(19) United States
(12) Patent Application Publication
(10) Pub. No.: US 2024/0095305 A1
(43) Pub. Date: Mar. 21, 2024

(54) METHOD AND APPARATUS FOR OBTAINING TRIANGLE IN GRAPH

(71) Applicant: KOREA ADVANCED INSTITUTE OF SCIENCE AND TECHNOLOGY, Daejeon (KR)

(72) Inventors: Min-Soo KIM, Daejeon (KR); Seyeon OH, Daegu (KR); Donghyoung HAN, Daejeon (KR); Inju NA, Daejeon (KR); Heeyong YOON, Daegu (KR); Sungwoo PARK, Daejeon (KR)

(21) Appl. No.: 18/463,521

(22) Filed: Sep. 8, 2023

(30) Foreign Application Priority Data
Sep. 8, 2022 (KR) 10-2022-0114371
Nov. 28, 2022 (KR) 10-2022-0162047

(51) Int. Cl. G06F 17/16

(52) U.S. Cl. CPC G06F 17/16

(57) ABSTRACT

Provided are a method and apparatus for obtaining a triangle in a graph. A computing device receives an adjacency matrix in which two vertices connected to an edge are expressed in rows and columns, divides the adjacency matrix into a plurality of blocks, searches for a search area including a plurality of blocks located at (I,K), (I,J), and (J,K) satisfying I>=J>=K (where I, J, and K are block indexes) for the plurality of blocks existing in the adjacency matrix, and identifies three vertices forming a triangle based on edge information existing in the search area.

### CROSS-REFERENCE TO RELATED APPLICATION

This application is based on and claims priority under 35 U.S.C. § 119 to Korean Patent Application Nos. 10-2022-0114371 and 10-2022-0162047, respectively filed on Sep. 8, 2022 and Nov. 28, 2022, in the Korean Intellectual Property Office, the disclosures of which are incorporated by reference herein in their entirety.

### BACKGROUND

### 1. Field

Embodiments of the disclosure relate to a method and apparatus for obtaining a triangle in a graph, and more particularly, to a method and apparatus for identifying vertices connected by edges in a graph and forming a triangle.

### 2. Description of the Related Art

Various types of data may be represented as graphs consisting of vertices and edges. For example, data in various industries such as web pages, social networking services (SNSs), communications, finance, and bio/healthcare are related to each other, and a relationship between these data may be represented as a graph consisting of vertices and edges. A relative importance between web pages may be measured by representing web pages as vertices and representing hyperlinks between the web pages as edges.

Also, after various Internet data are represented as a graph, it is possible to find friends on SNS, detect fake accounts, find web spam, and find communities based on vertices forming a triangle in the graph. However, as the amount of data is rapidly increasing, the size of a graph representing such data is also increasing. As the size of a graph increases, it is difficult to load and calculate the entire graph data into a memory at once. For example, it is difficult to load and calculate a graph including 1 trillion edges into a memory at once, and it takes a lot of resources and time to calculate vertices forming a triangle.

### SUMMARY

Embodiments of the disclosure provide a method and apparatus for rapidly identifying vertices forming a triangle in a graph.

Additional aspects will be set forth in part in the description which follows and, in part, will be apparent from the description, or may be learned by practice of the presented embodiments.

According to an embodiment of the disclosure, a method used by a computing device including one or more memories, one or more processors, and one or more input/output devices to obtain a triangle in a graph including vertices and edges includes receiving an adjacency matrix in which two vertices connected to each edge are expressed in rows and columns, dividing the adjacency matrix into a plurality of blocks, for the plurality of blocks existing in the adjacency matrix, searching for a search area including a plurality of blocks located at (I,K), (I,J), and (J,K) satisfying I>=J>=K (where I, J, and K are block indexes), and identifying three vertices forming a triangle based on edge information existing in the search area.

According to an embodiment of the disclosure, a computing device includes a memory into which an adjacency matrix in which two vertices connected to an edge are expressed in rows and columns is loaded, and a processor configured to identify a combination of vertices constituting a triangle for graph data stored in the memory by using a method of calculating a triangle in a graph, wherein the method of calculating a triangle in a graph includes dividing the adjacency matrix into a plurality of blocks, for the plurality of blocks existing in the adjacency matrix, searching for a plurality of blocks located at (I,K), (I,J), and (J,K) satisfying I>=J>=K (where I, J, and K are block indexes) as a search area, and identifying three vertices forming a triangle based on edge information existing in the search area.

### BRIEF DESCRIPTION OF THE DRAWINGS

The above and other aspects, features, and advantages of certain embodiments will be more apparent from the following description taken in conjunction with the accompanying drawings, in which:

FIG. 1 is a diagram illustrating a computing device for graph data compression, according to an embodiment of the disclosure;

FIG. 2 is a diagram illustrating a graph, according to an embodiment of the disclosure;

FIG. 3 is a diagram illustrating a format of graph data, according to an embodiment of the disclosure;

FIG. 4 is a diagram illustrating a method of obtaining a triangle in a graph based on an adjacency matrix, according to an embodiment of the disclosure;

FIG. 5 is a flowchart illustrating a method of obtaining a triangle in a graph, according to an embodiment of the disclosure;

FIG. 6 is a diagram illustrating a method of dividing an adjacency matrix, according to an embodiment of the disclosure;

FIGS. 7 to 11 are diagrams illustrating a method of identifying a block corresponding to a search area, according to an embodiment of the disclosure;

FIGS. 12 to 20 are diagrams illustrating a method of obtaining a triangle in a graph based on blocks, according to an embodiment of the disclosure;

FIG. 21 is a diagram illustrating a system architecture for obtaining a triangle in a graph, according to an embodiment of the disclosure; and

FIG. 22 is a diagram illustrating an experimental example regarding performance of a method of obtaining a triangle in a graph according to an embodiment of the disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein.

Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

A method and apparatus for obtaining a triangle in a graph according to an embodiment of the disclosure will be described in detail with reference to the accompanying drawings.

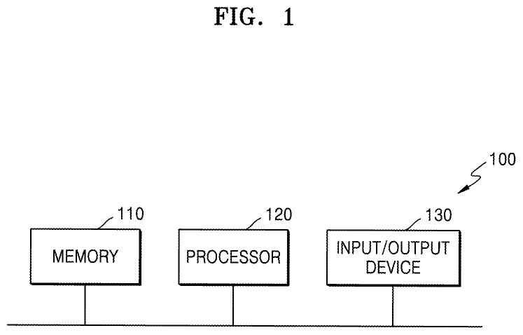

FIG. 1 is a diagram illustrating a computing device for graph data compression, according to an embodiment of the disclosure.

Referring to FIG. 1, a computing device 100 for processing a graph represented by a plurality of vertices and a plurality of edges includes one or more processors 120, one or more memories 110, and one or more input/output devices 130. In an embodiment, the computing device 100 may further include one or more graphics processing units (GPUs). The present embodiment is only an example for better understanding of the computing device 100, and an embodiment of the disclosure is not necessarily limited to the embodiment showing a structure of FIG. 1. Any of various types of devices for storing and processing data may be implemented as the computing device 100 of the present embodiment. Also, each operation performed by the computing device 100 may be implemented by software, may be loaded into the memory 110 (e.g., a main memory or a GPU memory), and then may be performed by the processor 120 (central processing unit (CPU) or GPU).

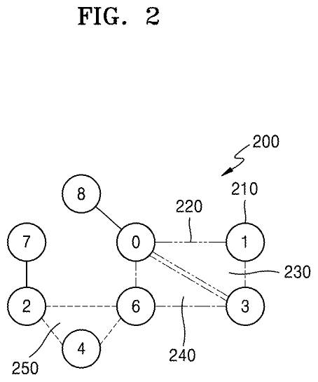

FIG. 2 is a diagram illustrating a graph, according to an embodiment of the disclosure.

Referring to FIG. 2, a graph 200 includes a plurality of vertices 210 and a plurality of edges 220. For example, the edge 220 may have a direction or may not have a direction. However, the following will be described based on an undirected graph.

Identification information expressed in numbers or characters may be assigned to the vertex 210 existing in the graph 200. For example, numbers that sequentially increase from a predefined number (e.g., 1) may be assigned to the vertices 210 of the graph 200. In addition, vertex identification information may be displayed in any of various forms such as a mixture of characters and numbers. However, the following will be described assuming that numbers that sequentially increase are assigned as identification information to the vertices 210 of the graph 200.

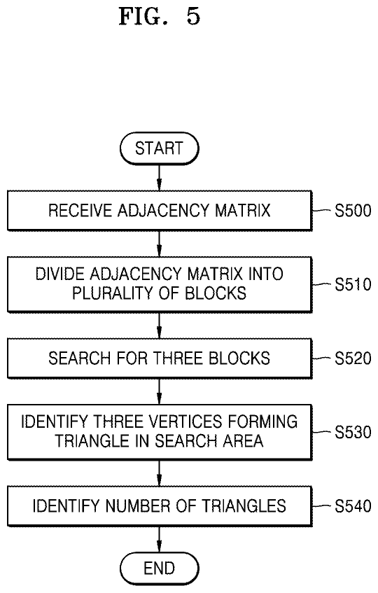

In the graph, there are triangles 230, 240, and 250 each including three vertices and three edges. For example, there is the triangle 230 including an edge between vertex 0 and vertex 1, an edge between vertex 1 and vertex 3, and an edge between vertex 0 and vertex 3. Also, there are the triangle 240 including vertices 0, 3, and 6 and edges between vertices 0, 3, and 6, and the triangle 250 including vertices 2, 4, and 6 and edges between vertices 2, 4, and 6. Triangles in a graph may be used in various fields such as finding friends on SNS, detecting fake accounts, finding web spam, and finding communities. A specific method of obtaining a triangle in a graph will be described below with reference to FIG. 5.

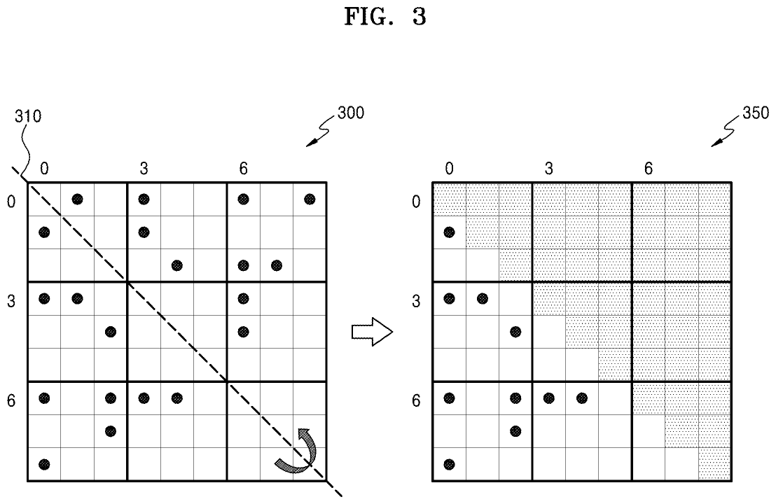

FIG. 3 is a diagram illustrating a format of graph data, according to an embodiment of the disclosure.

Referring to FIG. 3, graph data may be presented in the format of an adjacency matrix 300 in which two vertices of an edge are expressed in rows and columns. For example, when there is an edge connecting the vertex 2 to the vertex 1, the edge may be expressed as a predefined value (e.g., ‘1’) at an element (2, 1) of the adjacency matrix 300. Also, a portion of the adjacency matrix 300 where no edge exists may be expressed as a predefined value (e.g., ‘0’). For better understanding, in the present embodiment, an element with an edge in the adjacency matrix 300 is displayed as a circle, and an element with no edge is displayed as an empty space.

Identification information of each vertex and a mapped index respectively exist on horizontal and vertical axes of the adjacency matrix. In an embodiment, the identification information and the index may be the same or different from each other. In the present embodiment, the index is a value that sequentially increases from 0. For example, when the graph includes nine vertices, indexes of 0 to 8 may be respectively applied to the nine vertices. An edge of the graph may be expressed as indexes of two vertices. The present embodiment is merely an example, and the index assigned to each row and column of the adjacency matrix may be set to any of various values other than a value that increases from 0. Hereinafter, a position of each element in the adjacency matrix is indicated by using an index. For example, because an index of a first row of a matrix is 0 and an index of a second column is 1, (first row, second column) is expressed as (0, 1).

The computing device may perform a process of obtaining triangles in the graph based on the entire adjacency matrix. In another embodiment, in the adjacent matrix for an undirected graph, because an upper triangle area and a lower triangle area are symmetrical to each other with respect to a main diagonal 310, the computing device 100 may perform a process of obtaining triangles only for one of the two triangle areas. Hereinafter, a process of obtaining triangles in a graph based on an adjacency matrix 350 including only a lower triangle area from among two triangle areas with respect to a main diagonal of the adjacency matrix will be described.

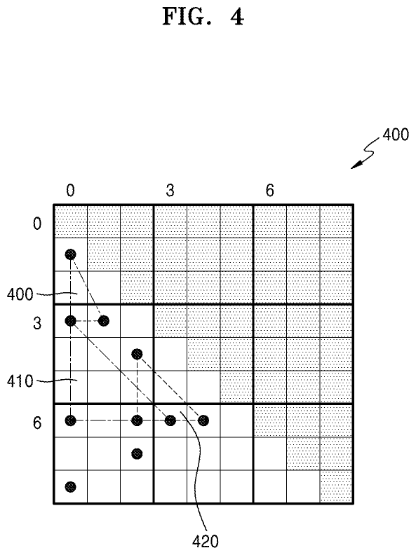

FIG. 4 is a diagram illustrating a method of obtaining a triangle in a graph based on an adjacency matrix, according to an embodiment of the disclosure.

Referring to FIG. 4, an adjacency matrix 400 includes edge information expressed by two vertices of a row and a column. In a graph of FIG. 2, edges connecting three vertices (0,1,3) forming the triangle 230 are located at (1,0), (3,0), and (3,1) of the adjacency matrix, and a triangle 400 is obtained by connecting positions of the three edges in the adjacency matrix 400. Also, triangles 410 and 420 are obtained by connecting positions of three edges forming the other triangles 240 and 250 in the adjacency matrix 400.

Shapes of the triangles 400, 410, and 420 of the adjacency matrix 400 corresponding to the triangles 230, 240, and 250 are right triangles. In other words, positions of three edges in the adjacency matrix 400 are (i,k), (i,j), and (j,k), and a relationship i>j>k is satisfied. Here, i, j, and k are indexes of three vertices.

When three vertices of the triangles 230, 240, and 250 in the graph of FIG. 2 are expressed in the order of i>j>k, (3,1,0), (6,3,0), and (6,4,2) are obtained, and when the three vertices are expressed as positions of edges of the adjacency matrix, {(3,0), (3,1), (1,0)}, {(6,0), (6,3), (3,0)}, and {(6,2), (6,4), (4,2)} are obtained.

Accordingly, the computing device may identify three vertices (i,j,k) forming a triangle in a graph by identifying positions (i,k), (i,j), and (j,k) of three edges satisfying i>j>k in an adjacency matrix. However, because the size of the adjacency matrix 400 of the graph including 1 trillion edges or more is large, it is difficult to load the adjacency matrix 400 into a memory at once and it takes a lot of time to identify all combinations of various positions of edges for the entire adjacency matrix 400. To solve these problems, the disclosure proposes a method of obtaining triangles in a graph by dividing the adjacency matrix 400 into blocks, which will be described with reference to FIG. 5.

FIG. 5 is a flowchart illustrating a method of obtaining a triangle in a graph, according to an embodiment of the disclosure.

Referring to FIG. 5, the computing device 100 receives graph data represented in the format of an adjacency matrix (S500). In another embodiment, when the computing device 100 receives graph data represented in any of various formats, the computing device 100 may generate an adjacency matrix in which two vertices of an edge are expressed in rows and columns.

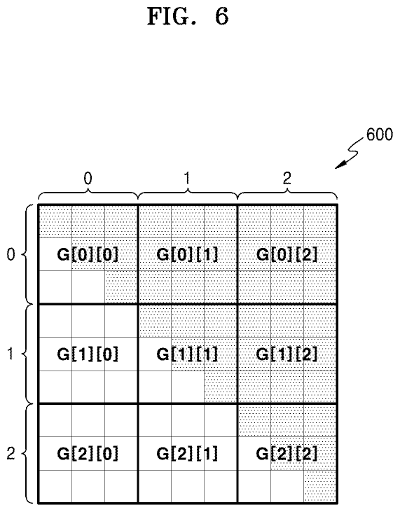

The computing device 100 divides the adjacency matrix into a plurality of blocks (S510). For example, the computing device 100 may recursively divide the adjacency matrix so that a size of a block is equal to or less than a size that may be loaded into a memory (e.g., a main memory or a GPU memory). An example where an adjacency matrix is divided into a plurality of blocks is illustrated in FIG. 6.

Referring back to FIG. 4, from the perspective of blocks, positions of three edges constituting the triangles 410, 420, and 430 of the adjacency matrix 400 are located within up to three blocks. For example, positions of three edges constituting the triangles 410, 420, and 430 of the adjacency matrix 400 may all exist in one block, two blocks, or three blocks. Also, when edges exist in three blocks, a positional relationship of the three blocks is a right triangle when each block is considered as each point, which is similar to a positional relationship of edges described with reference to FIG. 4.

Accordingly, the computing device searches for a search area including a plurality of blocks located at (I,K), (I,J), and (J,K) satisfying I>=J>=K (where I, J, and K are block indexes), for the plurality of blocks (S520). A plurality of search areas including various combinations of blocks satisfying the above condition may be obtained. Alternatively, the computing device 100 may search for a search area including a plurality of blocks located at (I,K), (I,J), and (J,K) satisfying I<=J<=K. In this case, the computing device 100 may identify three vertices (i,j,k) forming a triangle in a graph by identifying positions (i,k), (i,j), and (j,k) of three edges satisfying i<j<k in the search area. However, for convenience of explanation, the following will be described assuming that a plurality of blocks located at (I,K), (I,J), and (J,K) satisfying I>=J>=K are searched.

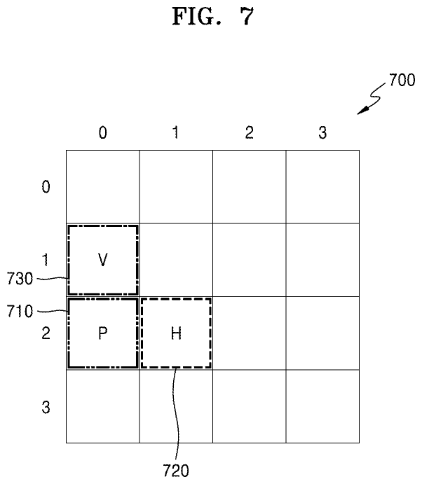

In an embodiment, when the graph is an undirected graph, the computing device 100 may identify a search area by searching for blocks existing in an upper triangle area or a lower triangle area with respect to a main diagonal of the adjacency matrix. An example of a method of searching for blocks existing in a lower triangle area is illustrated in FIGS. 7 to 11.

The computing device 100 identifies three vertices forming a triangle based on edge information existing in the search area (S530). The computing device 100 may perform a process of identifying a triangle in the graph based on up to three blocks corresponding to the search area, instead of the entire graph data. There may be various combinations of search areas including up to three blocks, and the computing device 100 may perform a process of obtaining a triangle for each search area of the various block combinations.

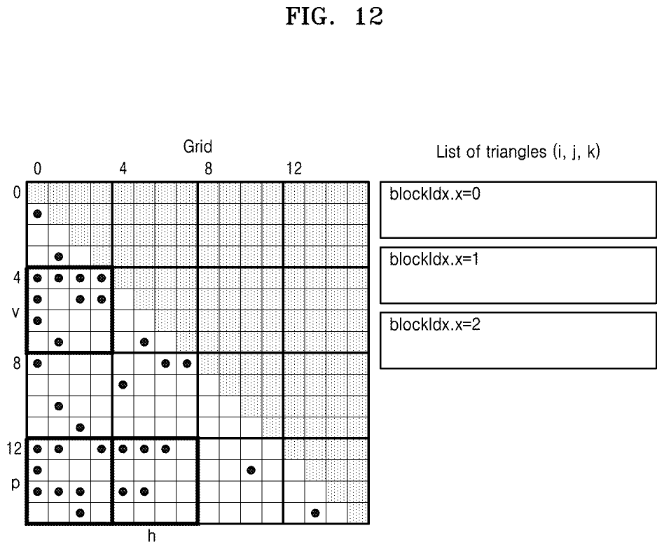

In another embodiment, the computing device 100 may identify and provide the number of triangles in the graph (S540). An example of identifying the number of triangles by using a plurality of threads is illustrated in FIGS. 12 to 20.

FIG. 6 is a diagram illustrating a method of dividing an adjacency matrix, according to an embodiment of the disclosure.

Referring to FIG. 6, the computing device 100 may generate a plurality of blocks by dividing an adjacency matrix 600 in which two vertices of an edge are expressed as a matrix. For example, the computing device 100 may recursively perform a process of quartering the adjacency matrix 600. Although the adjacency matrix 600 is quartered once in the present embodiment, a process of quartering a region generated by quartering (e.g., GOO) and then quartering a resulting region again may be recursively and repeatedly performed.

In an embodiment, the computing device 100 may divide the adjacency matrix 600 so that a size of a final block generated by recursive division is equal to or less than a predefined size. For example, when the computing device 100 processes graph data by using a GPU, the computing device 100 may divide the graph data so that a size of a block is equal to or less than the size of a GPU memory.

In the present embodiment, an example of dividing the adjacency matrix 600 into 3*3 blocks is illustrated. Each block may be expressed as index information. In a matrix including blocks, an index of 0 to 2 may be assigned to each row and an index of 0 to 2 may be assigned to each column. In this case, positions of the blocks may be expressed as (0,0), (1,0), (2,0), (0,1) . . . , and (2,2). A range and a start value of a block index value may be modified in various ways according to embodiments.

FIGS. 7 to 11 are diagrams illustrating a method of identifying a block of a search area, according to an embodiment of the disclosure.

Referring to FIG. 7, 4*4 blocks generated by dividing an adjacency block 700 are illustrated. It is assumed that a graph is an undirected graph, and blocks of a lower triangle area with respect to a main diagonal of the adjacency matrix 700 are searched. A block index of 0 to 3 is assigned to a row and a column in a block matrix.

The computing device 100 searches for three blocks 710, 720, and 730 satisfying block indexes I>=J>=K. Positions of the three blocks are (I,K), (I,J), and (J,K). Hereinafter, a block located at (I,K) is referred to as a pivot block 710, a block located at (I,J) is referred to as a horizontal block 720, and a block located at (J,K) is referred to as a vertical block 730.

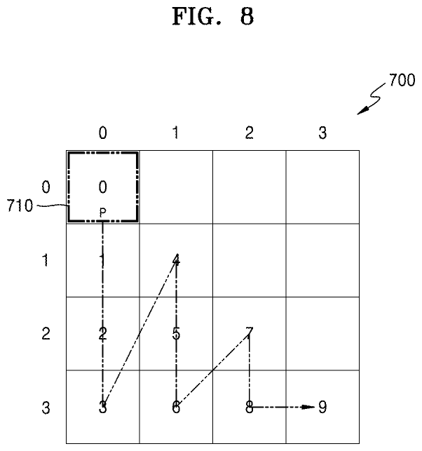

Referring to FIG. 8, a method of searching for the pivot block 710 is illustrated. The computing device 100 selects the pivot block 710 in a column direction. For example, the computing device 100 searches for the pivot block 710 downward from (0,0), and when the search for a first column is completed, the computing device 100 performs a process of searching for the pivot block 710 in a second column. That is, the computing device 100 may sequentially select blocks 1 to 9.

FIG. 8 is merely an example for better understanding, and the pivot block 710 may be searched in any of various ways. For example, because the computing device 100 only needs to select all blocks generated by dividing the adjacency matrix (e.g., blocks of a lower triangle area of the adjacency matrix) one by one as the pivot block 710, the computing device 100 may select the pivot block 710 in a row direction or may select each block as the pivot block 710 in an arbitrary order.

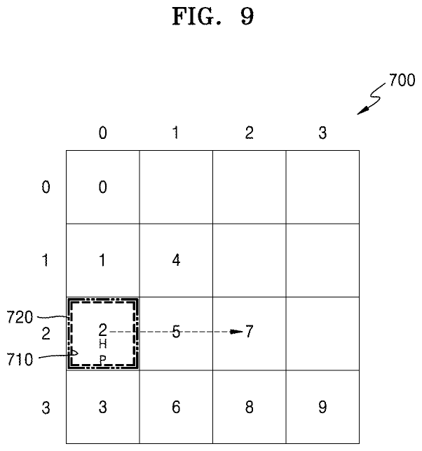

Referring to FIG. 9, a method of searching for the horizontal block 720 is illustrated. The computing device 100 searches for the horizontal block 720 rightward from the position of the pivot block 710. For example, when a block (2,0) is selected as the pivot block 710, the computing device searches for the horizontal block 720 while moving rightward from the block (2,0) that is the position of the pivot block 710. In this case, blocks 2, 5, and 7 may be the horizontal block 720.

FIG. 9 is merely an example for better understanding, and the horizontal block 720 may be searched in any of various ways. Because the position of the pivot block 710 is (I,K) and the position of the horizontal block 720 is (I,J), the pivot block 710 and the horizontal block 720 exist in the same row (i.e., row I). Accordingly, when the pivot block 710 is selected, the computing device 100 may select a block located at the same row as the position of the pivot block 710 as the horizontal block 720 in any of various orders. Also, because the condition I>=J>=K should be satisfied, the computing device 100 may exclude a block located on the left side of the pivot block 710 from a search target.

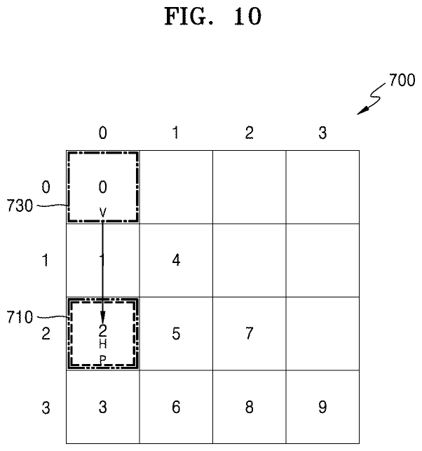

Referring to FIG. 10, a method of searching for the vertical block 730 is illustrated. The computing device 100 searches for the vertical block 730 downward from a side above the pivot block 710. For example, when the block (2,0) is selected as the pivot block 710, the computing device 100 searches for the vertical block 730 while moving downward from (0,0) that is an uppermost block of the same column as the pivot block downward to (2,0) that is the position of the pivot block. In this case, blocks 0, 1, and 2 may be the vertical block 730.

FIG. 10 is merely an example for better understanding, and the vertical block 730 may be searched in any of various ways. Because the position of the pivot block 710 is (I,K) and the position of the vertical block 720 is (J,K), the pivot block 710 and the vertical block 730 exist in the same column (i.e., column K). Accordingly, when the pivot block 710 is selected, the computing device 100 may select a block located in the same column as the position of the pivot block 710 as the vertical block 730 in any of various orders. Also, because the condition I>=J>=K should be satisfied, the computing device 100 may exclude a block located below the pivot block 710 from a search target.

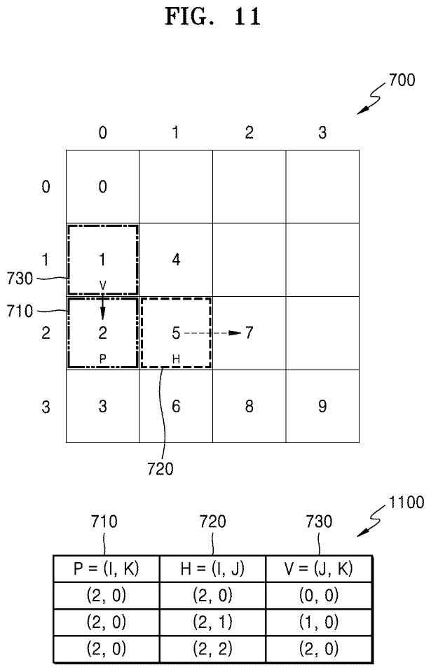

Referring to FIG. 11, a method of searching for the pivot block 710, the horizontal block 720, and the vertical block 730 satisfying I>=J>=K is illustrated. In the present embodiment, it is assumed that the computing device 100 selects the block (2,0) as the pivot block 710.

When the pivot block 710 is selected, the computing device 100 searches for the horizontal block 720 while moving rightward from (2,0) that is the position of the pivot block by using the method of FIG. 8. Three blocks (2,0), (2,1), and (2,2) may be the horizontal block 720.

When the search for the horizontal block 720 is completed, the computing device 100 searches for the vertical block 730 by using the method of FIG. 9. Blocks located above the position (2,0) of the pivot block 710, that is, (0,0), (1,0), and (2,0), may be the vertical block 730.

The computing device 100 may determine a combination of the vertical block 710, the horizontal block 720, and the vertical block 730 as a search area 1100. Because the number of horizontal blocks 720 searched in the present embodiment is 3 and the number of vertical blocks 730 is 3, a total of 9 different combinations (the pivot block 710, the horizontal block 720, the vertical block 730) may be made. However, because positions of the pivot block 710, the horizontal block 720, and the vertical block 730 should exist at (I,K), (I,J), and (J,K) satisfying the condition I>=J>=K, the number of combinations of blocks satisfying the condition is 3.

For example, when a position of the pivot block 710 is (2,0) and a position of the horizontal block 710 is (2,0), a position satisfying the above condition from among positions of the vertical block 730 is only one (0,0). In other words, when a position of the pivot block 710 and a position of the horizontal block 720 are determined, a position of the vertical block 730 satisfying the above condition is determined. Accordingly, because a process of obtaining a triangle in a graph only needs to be performed for three different combinations of blocks without having to perform a process of obtaining a triangle in a graph for all nine different combinations, the amount of calculation may be reduced.

In this way, the computing device 100 may identify various combinations of the horizontal block 720 and the vertical block 730 for each pivot block 710 searched in FIG. 8 in advance, and then may store the combinations as the search area 1100. That is, the search area 1100 may include a list of various combinations of the pivot block 710, the horizontal block 720, and the vertical block 730.

FIGS. 12 to 20 are diagrams illustrating a method of obtaining a triangle in a graph based on blocks, according to an embodiment of the disclosure.

Referring to FIG. 12, an adjacency matrix of an undirected graph is divided into 4*4 blocks as shown in FIG. 7. Referring to FIG. 7, in the present embodiment, a pivot block, a horizontal block, and a vertical block are respectively blocks (3,0), (3,1), and (1,0).

In an embodiment, calculation for obtaining a triangle in a graph may be performed by using one or more GPUs. A GPU may include a plurality of streaming multiprocessors (SMs), and each of the SMs may include a plurality of cores. Each core may execute one or more threads. Accordingly, in the present embodiment, a case of processing graph data by using three calculation blocks including two threads will be described. A plurality of calculation blocks may be implemented as a plurality of GPUs, or a plurality of cores or a plurality of SMs in a GPU.

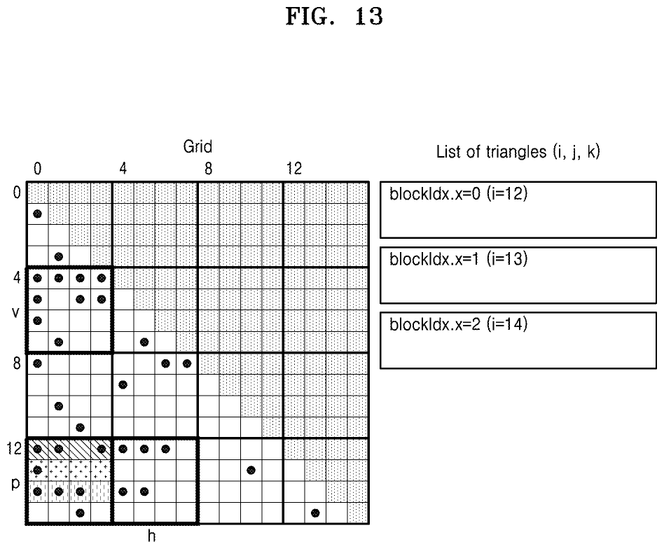

Referring to FIG. 13, the computing device 100 allocates the three calculation blocks to calculation processes of rows of the pivot block. For example, the first calculation block is allocated to a first row (i=12) of the pivot block, and the second and third calculation blocks are allocated to a second row (i=13) and a third row (i=14) of the pivot block. Each calculation block performs calculation on each allocated row. For convenience of explanation, a calculation process of the first calculation block will be described.

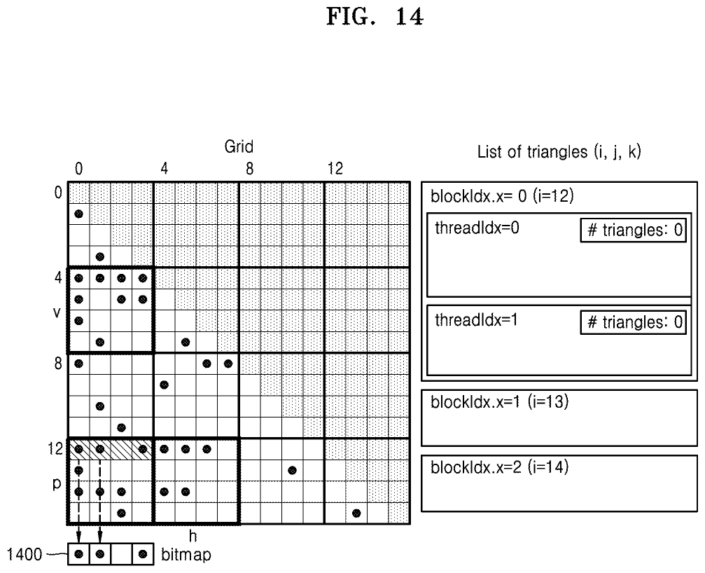

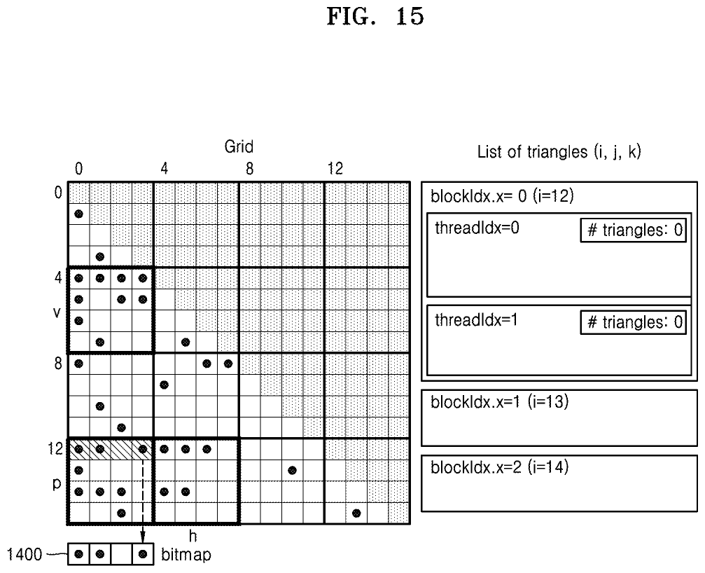

Referring to FIGS. 14 and 15, a calculation process of the first calculation block of the computing device 100 is illustrated. The first calculation block includes two threads. The computing device 100 may perform a process of obtaining a triangle in a graph on the first row (i=12) of the pivot block in parallel by using the two threads. For example, the first thread identifies a position (12,0) of an edge located in the first row (i=12) of the pivot block, and the second thread identifies a position (12,1) of an edge. When the identification of the position (12,0) of the edge is completed, the first thread identifies a position (12,3) of an edge that is located next. The first calculation block determines through the two threads that edges respectively exist in columns 0, 1, and 3 in the case of the first row (i=12) of the pivot block. In an embodiment, the computing device 100 may store a position where an edge exists as a bitmap 1400 (e.g., stores when an edge exists). In the present embodiment, for better understanding, a column with an edge is marked with a circle in the bitmap 1400.

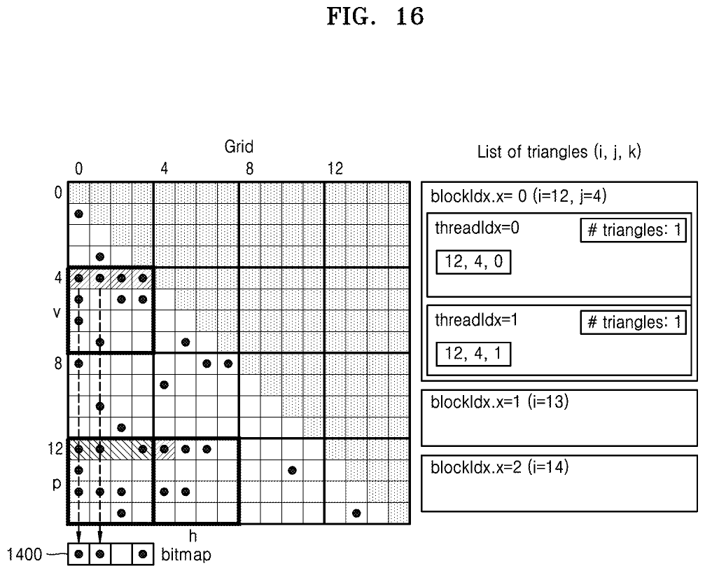

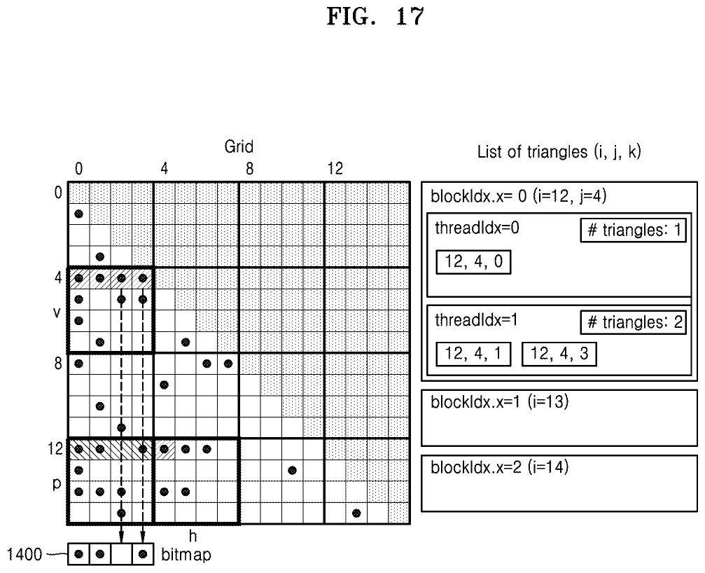

Referring to FIGS. 16 and 17, the computing device selects a position of an edge of the horizontal block located in the same row as the first row (i=12) of the pivot block. For example, the computing device selects a position (12,4) of an edge of the horizontal block.

A positional relationship of edges constituting a triangle in the adjacency matrix is (i,k), (i,j), and (j,k), and i>j>k should be satisfied. Also, (i,k) is a position of an edge in the pivot block, (i,j) is a position of an edge in the horizontal block, and (j,k) is a position of an edge in the vertical block.

In FIG. 17, a position of an edge of the horizontal block is (12,4), and thus, j=4. In this case, a position of an edge that may be selected in the vertical block is only (4,x). That is, a first row of the vertical block is obtained. Because a position of an edge of a second row of the vertical block is (5,x), 5 is greater than the value of j, and thus, may not be selected. Accordingly, the computing device 100 only needs to search for existence of a triangle in the first row of the vertical block.

The first thread and the second thread determine whether there is an edge forming a triangle in the vertical block. For example, the first and second threads identify a position of an edge existing in the first row of the vertical block (i.e., a fifth row of the adjacency matrix). The computing device 100 may determine through the first and second threads that edges are located at (4,0), (4,1), (4,2), and (4,3) in the case of the first row of the vertical block.

The computing device 100 determines whether there is an edge of the pivot block in the same column as each edge located in the vertical block through the first thread and the second thread. In an embodiment, the computing device 100 may determine whether there is an edge of the pivot block and an edge of the vertical block in the same column by using the bitmap 1400. Because there is an edge (12(=i),0(=k)) of the pivot block in the same column as an edge (4(=j),0(=k)) of the vertical block, the first thread identifies three vertices (i,j,k)=(12,4,0) constituting a triangle, and increases the number of triangles by 1. Also, because there is an edge (12,1) of the pivot block in the same column as an edge (4,1) of the vertical block, the second thread may identify three vertices (12,4,1) constituting a triangle, and may increase the number of triangles by 1.

Referring back to FIG. 17, there is no edge of the pivot block in the same column as an edge (4,2) of the vertical block. Because there is an edge (12,4) of the pivot block in the same column as an edge (4,3) of the vertical block, the second thread identifies three vertices (12,4,3) constituting a triangle, and increases the number of triangles by 1.

In this way, the computing device 100 may search for the vertices (12,4,0), (12,4,1), (12,4,3) of triangles including a first column (i=12) of the pivot block and a first column (j=4) of the horizontal block through the first calculation block.

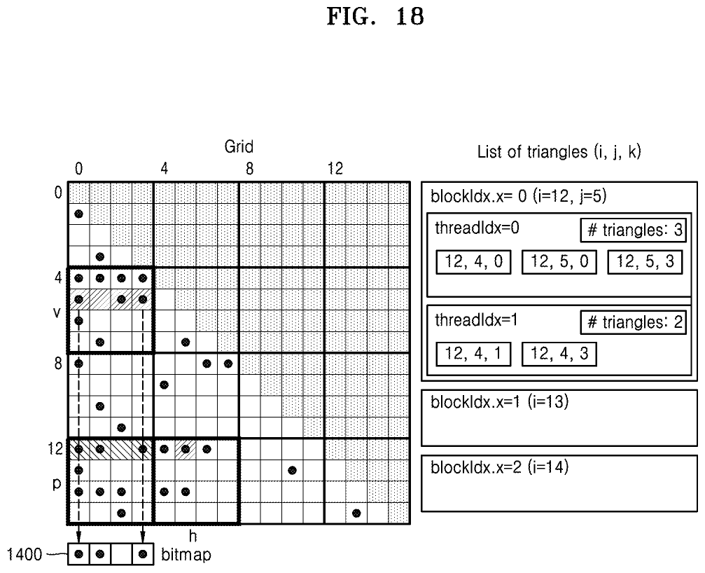

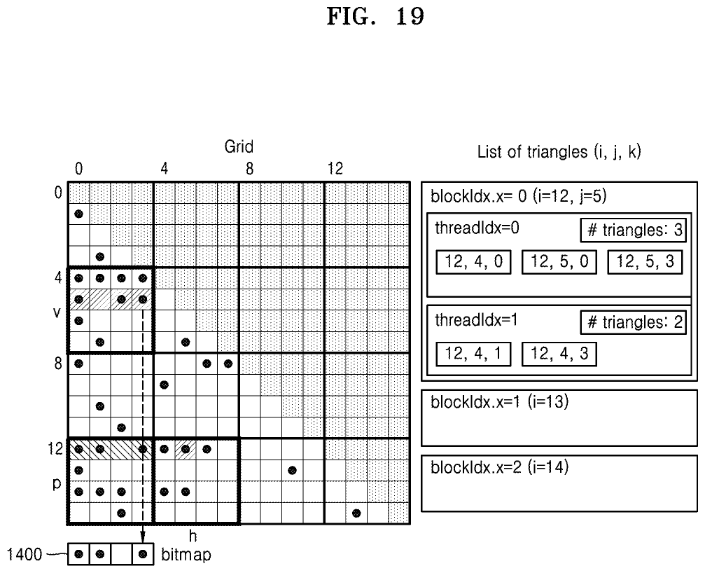

Referring to FIGS. 18 and 19, the computing device 100 selects an edge of a second column (j=5) in the horizontal block, and identifies vertices forming a triangle by searching a second row (i.e., a row corresponding to j=5) of the vertical block.

For example, the computing device 100 identifies edges (5,0), (5,2), and (5,3) located in the second row of the vertical block by using the first and second threads. The computing device 100 determines whether there is an edge of the pivot block located in the same column as each edge by using the two threads. Because there are edges of the pivot block located in the same columns as the edges (5,0) and (5,3) existing in a first column and a third column of the second row of the vertical block, the first thread identifies three vertices (12,5,0) and (12,5,3) forming triangles, and increases the number of triangles by 2.

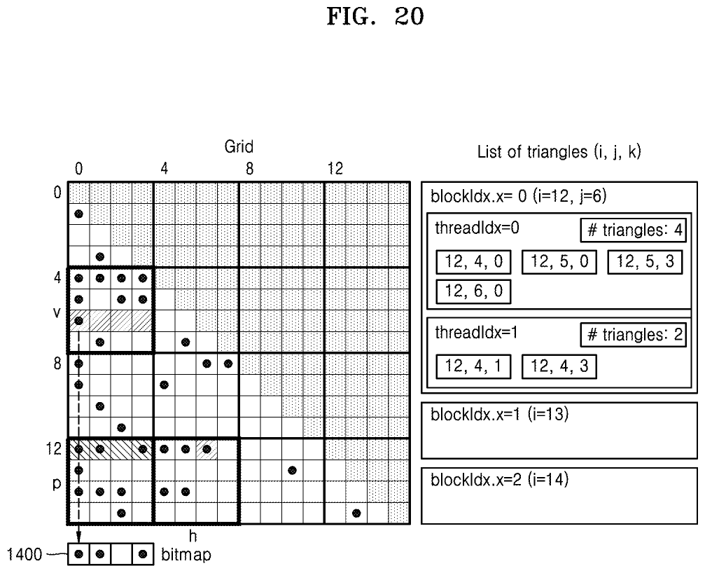

Referring to FIG. 20, the computing device 100 selects an edge of a third column (j=6) of the horizontal block, and identifies vertices forming a triangle by searching a third row (i.e., a row corresponding to j=6) of the vertical block. Because there is an edge in a first column in the case of the third row of the vertical block and there is an edge of the pivot block in the same column, the first thread identifies new vertices (12,6,0) forming a triangle, and increases the number of triangles by 1.

As a result, a total number of triangles obtained by searching the first row (i=12) of the pivot block, four columns (j=4,5,6,7) of the horizontal block, and the corresponding vertical block is 4.

The second calculation block and the third calculation block perform a process of obtaining a triangle on a second row (i=13) and a third row (i=14) of the pivot block in the same manner as above. When the first calculation block completes a process of obtaining a triangle on the first row of the pivot block, the first calculation block performs a process of obtaining a triangle on a fourth row (i=15) of the pivot block again.

When a process of obtaining a triangle in a search area of the pivot block, the horizontal block, and the vertical block is completed, the computing device 100 performs a process of obtaining a triangle for a next search area again. For example, when a process of obtaining a triangle for three blocks (2,0), (2,1), and (1,0) is completed in the example of FIG. 11, the computing device 100 performs a process of obtaining a triangle for three blocks (2,0), (2,2), and (2,0) that are a next search area. In an embodiment, processes of obtaining triangles for a plurality of search areas may be performed in parallel.

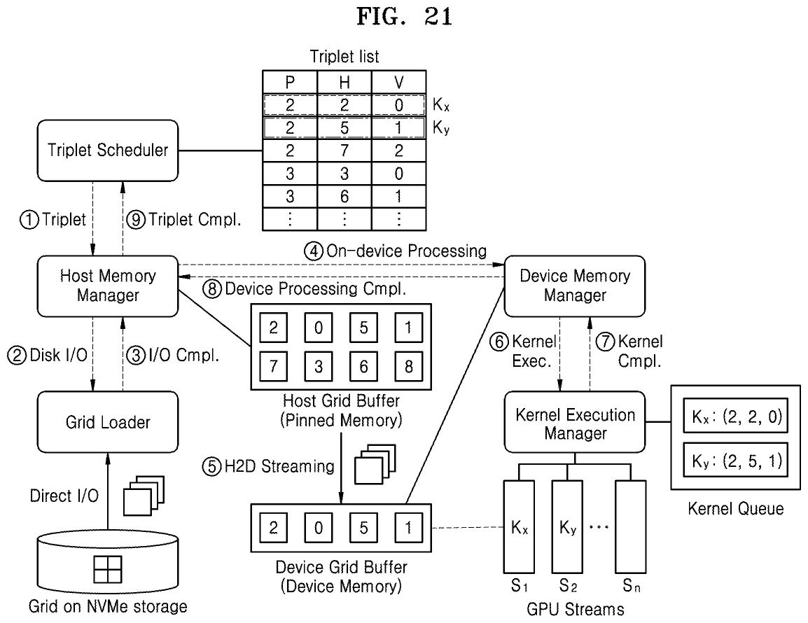

FIG. 21 is a diagram illustrating a system architecture for obtaining a triangle in a graph, according to an embodiment of the disclosure.

Referring to FIG. 21, the computing device 100 includes an auxiliary storage device, a memory, and a processor. The auxiliary storage device may be a Non-Volatile Memory Express (NVMe)-based storage medium. In addition, any of conventional storage media of various interfaces may be used as the auxiliary storage medium of the present embodiment.

The processor identifies and stores a plurality of search areas for obtaining a triangle in a graph, by using the method described with reference to FIGS. 7 to 11. A search area may be expressed in the form of a list of triplets of (pivot block, horizontal block, vertical block). In an embodiment, a search area may be expressed as position values of a pivot block, a horizontal block, and a vertical block as shown in FIG. 11. In another embodiment, a search area may be expressed as a combination of block indexes (I,J, K) as in the present embodiment. Positions (I,K), (I,J), and (J,K) of the pivot block, the horizontal block, and the vertical block may be identified from the block indexes (I,J,K). The following will be described assuming that information about blocks corresponding to a search area is expressed in the form of the block indexes (I,J,K).

The processor reads the pivot block, the horizontal block, and the vertical block corresponding to the search area from the auxiliary storage device and loads the pivot block, the horizontal block, and the vertical block into the memory. For example, referring to FIG. 7, when indexes corresponding to the pivot block, the horizontal block, and the vertical block are (2,2,0), the processor loads blocks (2,0), (2,0), and (0,0) into the memory. Because the pivot block and the horizontal block are the same, only one needs to be loaded.

When calculation processes for obtaining a graph triangle are performed in parallel by using a plurality of GPU streams, the processor may load a plurality of search areas into a plurality of GPU memories. In the present embodiment, blocks corresponding to block indexes (2,2,0) corresponding to a first search area and blocks corresponding to block indexes (2,5,10) are respectively loaded into GPU memories.

The processor loads blocks corresponding to a first search area into a first GPU memory through a first GPU stream, and loads blocks corresponding to a second search area into a second GPU memory through a second GPU stream. One or more GPUs perform calculation processes for obtaining a graph triangle in parallel through a plurality of threads on blocks of search areas loaded into the first GPU memory and the second GPU memory.

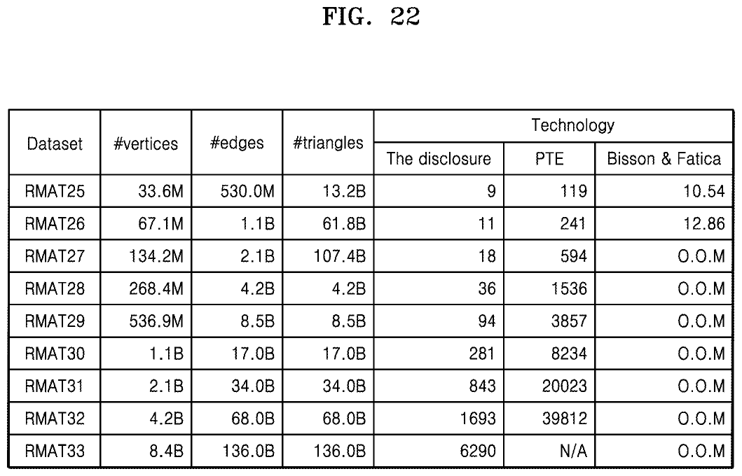

FIG. 22 is a diagram illustrating an experimental example regarding performance of a graph data processing method according to an embodiment of the disclosure.

Referring to FIG. 22, a result of on experiment on a time required to obtain the number of triangles in a graph by using regenerative medicine advanced therapy (RMAT) synthetic graph data, which is widely used as a graph processing performance benchmark, is shown. It is found that a time required to obtain a graph triangle when an embodiment of the disclosure is applied is shorter than that of a conventional method.

The disclosure may also be embodied as computer-readable code on a computer-readable recording medium. The computer-readable recording medium includes any data storage device that may store data which may be thereafter read by a computer system. Examples of the computer-readable recording medium include a read-only memory (ROM), a random-access memory (RAM), a compact disk (CD)-ROM, a magnetic tape, a floppy disk, and an optical data storage device. The computer-readable recording medium may also be distributed over network-coupled computer systems so that the computer-readable code is stored and executed in a distributive manner.

According to an embodiment of the disclosure, a time required to identify a triangle in a graph may be reduced In another embodiment, distributed processing may be performed by using one or more graphics processing units (GPUs). Also, when a triangle is obtained, a single machine may process graph data including 1 trillion edges.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by one of ordinary skill in the art that various changes in form and details may be made therein without departing from the spirit and scope of the disclosure as defined by the following claims.

What is claimed is:

1. A method used by computing device comprising one or more memories, one or more processors, and one or more input/output devices to obtain triangle count in a graph comprising vertices and edges, the method comprising:
receiving an adjacency matrix in which two vertices connected to each edge are expressed in rows and columns;
dividing the adjacency matrix into a plurality of blocks;
for the plurality of blocks existing in the adjacency matrix, searching for a search area comprising a plurality of blocks located at (I,K), (I,J), and (J,K) satisfying I>=J>=K (where I, J, and K are block indexes); and
identifying three vertices forming a triangle based on edge information existing in the search area.

2. The method of claim 1, wherein the searching comprises searching for blocks existing in an upper triangle area or a lower triangle area with respect to a main diagonal of the adjacency matrix.

3. The method of claim 1, wherein the dividing comprises recursively dividing the adjacency matrix so that a size of a block is equal to or less than a size of a graphics processing unit (GPU) memory.

4. The method of claim 1, wherein the identifying of the three vertices comprises identifying three edges located at (i,k), (i,j), and (j,k) satisfying i>j>k (where i, j, and k are vertex indexes) in the search area.

5. The method of claim 1, wherein the searching comprises:
selecting a pivot block located at (I,K) while moving in a column direction;
selecting a horizontal block located at (I,J) while moving rightward from the position of the pivot block; and
selecting a vertical block located at (J,K) while moving downward from a side above the pivot block to the position of the pivot block.

6. The method of claim 5, wherein the selecting of the vertical block comprises determining the position (J,K) of the vertical block based on the position (I,K) of the pivot block and the position (I,J) of the horizontal block.

7. The method of claim 5, wherein the identifying of the three vertices comprises:
selecting a first edge existing in the pivot block;
selecting a second edge existing in same row as the first edge in the horizontal block;
selecting a third edge existing in same column as the first edge in the vertical block; and
identifying three vertices i, j, and k constituting a triangle based on a position (i,k) of the first edge, a position (i,j) of the second edge, and a position (j,k) of the third edge.

8. The method of claim 7, further comprising loading the pivot block, the horizontal block, and the vertical block into a GPU memory,
wherein the identifying of the three vertices is performed by a GPU processor.

9. A computing device comprising:
memories into which an adjacency matrix in which two vertices connected to an edge are expressed in rows and columns is loaded; and
processors configured to identify a combination of vertices constituting a triangle for graph data stored in the memories by using a method of calculating a triangle in a graph,
wherein the method of calculating a triangle in a graph comprises:
dividing the adjacency matrix into a plurality of blocks;
for the plurality of blocks existing in the adjacency matrix, searching for a plurality of blocks located at (I,K), (I,J), and (J,K) satisfying I>=J>=K (where I, J, and K are block indexes) as a search area; and
identifying three vertices forming a triangle based on edge information existing in the search area.

10. A computer-readable recording medium having recorded thereon a computer program for performing the method of claim 1.
